(19) United States
(12) Patent Application Publication
(10) Pub. No.: US 2009/0249303 A1
(43) Pub. Date: Oct. 1, 2009

(54) RANDOM ACCESS TO HISTORICAL PROGRAM STATE FOR ENHANCED DEBUGGING

(75) Inventors: John William Duffell, Winchester (GB); Ian Derek Heritage, Chandlers Ford (GB); Mark Stephen Taylor, Southampton (GB); Henry Tonnison, Winchester (GB)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/060,129

(22) Filed: Mar. 31, 2008

(51) Int. Cl. G06F 11/36

(52) U.S. Cl. 717/128

(57) ABSTRACT

A method in one embodiment includes: executing a program; performing testing on the program; logging every input to the program during the testing; logging every result during testing of the program; storing the logged results; and allowing a user to search the logged results. If a failure occurs during the testing: performing a comparison between a successful testing of the program and the failed testing of the program; rerunning the successful testing and the failed testing in parallel; analyzing the logged results for determining occurrence of events during testing of the program; generating a timeline of the events; and outputting the timeline of the events.

### BACKGROUND OF THE INVENTION

The present invention relates to program debugging, and more particularly, this invention relates to an enhanced debugging process based on more complete program execution logging.

Currently when a program is executed, it either completes successfully or fails. Upon a failure the information as to why it has failed can be found by the program exit criteria and trace. Even if the program has a good level of error reporting and trace, the program developer is still missing information they can only obtain by rerunning the program and replicating the scenario which created the error.

This method of error correction, in addition to being time consuming, is also sometimes not possible to do. If the scenario which created the error can be recreated and the program developer inadvertently steps over the code that caused the failure, it is currently not possible to find it out what actually happened to create the error.

### SUMMARY OF THE INVENTION

A method in one embodiment includes: executing a program; performing testing on the program; logging every input to the program during the testing; logging every result during testing of the program; storing the logged results; and allowing a user to search the logged results. If a failure occurs during the testing: performing a comparison between a successful testing of the program and the failed testing of the program; rerunning the successful testing and the failed testing in parallel; analyzing the logged results for determining occurrence of events during testing of the program; generating a timeline of the events; and outputting the timeline of the events.

Any of these embodiments may be implemented in a logic function, program or software.

Other aspects, advantages and embodiments of the present invention will become apparent from the following detailed description, which, when taken in conjunction with die drawings, illustrate by way of example the principles of the invention.

### BRIEF DESCRIPTION OF THE DRAWINGS

FIG. 1 shows a simplified flow chart of a method according to the prior art.

FIG. 2 shows a simplified flow chart of a method according to one embodiment.

FIG. 3 shows a flow chart of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of methods for enhanced debugging.

In one general embodiment, a method comprises executing a program; performing testing on the program; logging every input to the program during the testing; logging every result during testing of the program; storing the logged results; allowing a user to search the logged results; if a failure occurs during the testing: performing a comparison between a successful testing of the program and the failed testing of the program; rerunning the successful testing and the failed testing in parallel; analyzing the logged results for determining occurrence of events during testing of the program; generating a timeline of the events; and outputting the timeline of the events.

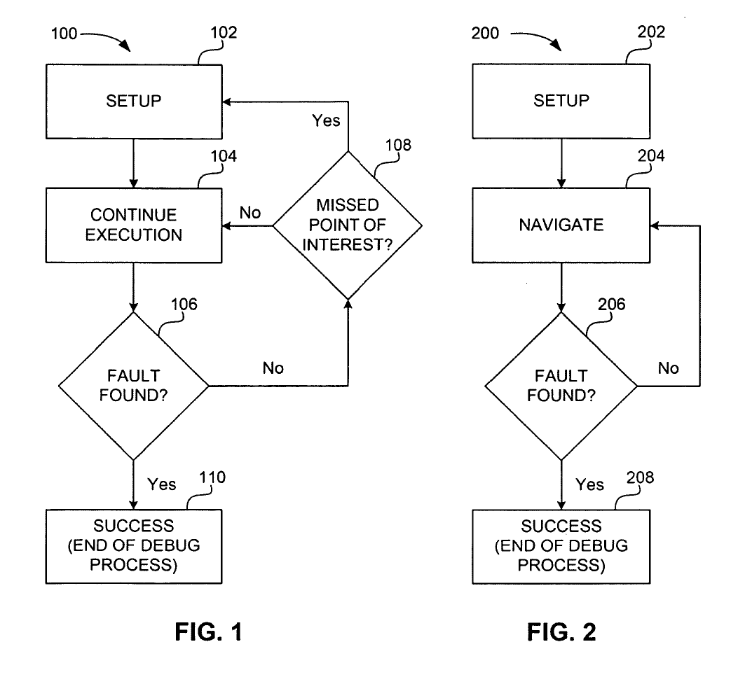

FIG. 1 illustrates a method 100 according to the prior art. In operation 102, a program is setup to begin execution. The program developer would have to search through the program until the point where the error occurred according to error logging.

In operation 104, the program execution continues with the goal of reaching the point at which the error occurred according to error logging.

In operation 106, it is determined whether the fault, in the program has been found. If the fault, that, caused the error reported in the error log is found, then the debug process continues to operation 110 as it has been successful and the debug process ends. If the fault in the program has not been found, it must be determined whether the point of interest as reported by the error log has been reached in operation 108.

In operation 108, it is determined whether the point of interest has been missed, or passed over in the execution of the program. If it has been missed, then the program must be setup again in operation 102. If it has not been missed, then the program can continue execution in operation 104.

In operation 110, the debug process ends as the error has been found in the execution of the program.

In contrast to the methodology of the prior art method 100, FIG. 2 illustrates a method 200 according to one embodiment. As an option, the present method 200 may be implemented in the context of functionality and architecture of software or a logic function. Of course, the method 200 may be carried out in any desired environment. It should be noted that the aforementioned definitions may apply during the present description.

With continued reference to FIG. 2, in operation 202 a program is setup to begin execution. The program developer may search through the program until the point where the error occurred in the execution of the program is reached according to error logging.

In operation 204, the program developer can navigate through the execution of the program by jumping to a point in the execution of the program, by moving forward through the execution of the program, or by moving backward through the execution of the program.

In operation 206, it is determined whether the fault in the program has been found. If the fault that caused the error reported in the error log is found, then the debug process continues to operation 208 as it has been successful and the debug process ends. If the fault in the program has not been found, the user has the ability to return to operation 204 to navigate to another point in the execution of the program to find where the error occurs. This methodology may be repeated until the error in the execution of the program has been found. Then the program developer may continue on to operation 208 and the process has been successful.

In operation 208, the debug process ends as the error has been found in the execution of the program.

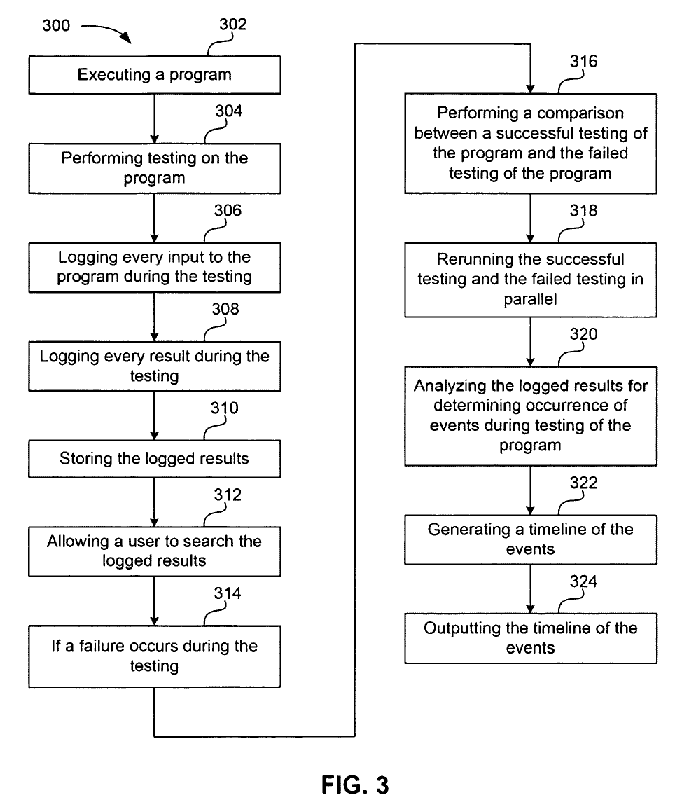

FIG. 3 illustrates a method 300 according to one embodiment. As an option, the present method 300 may be implemented in the context of functionality and architecture of software or a logic function. Of course, the method 300 may be carried out in any desired environment. It should be noted that the aforementioned definitions may apply during the present description.

With continued reference to FIG. 3, in operation 302 a program is executed.

In operation 304, testing is performed on the program as it executes.

In operation 306, every input to the program is logged during the testing.

In operation 308, every result during the testing is logged.

In operation 310, the logged results are stored.

In operation 312, a user is allowed to search the logged results.

In operation 314, it is determined if a failure occurs during testing.

In operation 316, if a failure occurred during testing, a comparison between a successful testing of the program and the failed testing of the program is performed.

In operation 318, if a failure occurred during testing, the successful testing and the failed testing are rerun in parallel.

In operation 320, if a failure occurred during testing, the logged results are analyzed for determining occurrence of events during testing of the program.

In operation 322, if a failure occurred during testing, a timeline of the events is generated.

In operation 324, if a failure occurred during testing, the timeline of the events is output.

The advantages of this testing methodology are the ability to see more completely what happened when the program, was executed with an error. No trace is needed and the information is presented in a familiar fashion to the program developer, meaning the information is presented in the same way as a program developer is used to when debugging a program. In addition, when a fault is detected, the program developer is able to execute the program in reverse to quickly hunt down the fault in the program.

The program execution could be logged in an automated test environment, and upon a test failure, a difference can be performed between a successful run and the failed run. The difference in variable values could be highlighted and the tests replayed in parallel, in order for faster bug resolution.

A timeline can be produced to allow the developer to see the points when a certain line was hit or an event occurred (for example, what variable changed, what object was created, garbage collection run, etc.).

In one approach, debug information is logged and forms the basis of how the program will be replayed later. The information may then be imported into an IDE, where a program developer can navigate to a point of execution consistent with the reported error. The program developer may be able to use standard debug navigation and the additional facility to jump to any point in the program and rewind execution of the program.

It will also be clear to one skilled in the art that the method of the present invention may suitably be embodied in a logic apparatus comprising logic to perform various steps of the methodology presented herein, and that such logic may comprise hardware components or firmware components.

It will be equally clear to one skilled in the art that the logic arrangement in various approaches may suitably be embodied in a logic apparatus comprising logic to perform various steps of the method, and that such logic may comprise components such as logic gates in, for example, a programmable logic array. Such a logic arrangement may further be embodied in enabling means or components for temporarily or permanently establishing logical structures in such an array using, for example, a virtual hardware descriptor language, which may be stored using fixed or transmittable carrier media.

It will be appreciated that the methodology described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

Embodiments of the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present; or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Communications components such as input/output or I/O devices (including but not limited to keyboards, displays, pointing devices, etc.) can be coupled to the system either directly or through intervening I/O controllers.

Communications components such as buses, interfaces, network adapters, etc. may also be coupled to the system to enable the data processing system, e.g., host, to become coupled to other data processing systems or remote printers or storage devices through intervening private or public networks. Modems, cable modem and Ethernet cards are just a few of the currently available types of network adapters.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
executing a program;
performing testing on the program;
logging every input to the program during the testing of the program;
logging every result during the testing of the program;
storing the logging of every result during the testing of the program;
allowing a user to search the stored logging of every result during the testing of the program;
if a failure occurs during the testing of the program:
performing a comparison between a successful testing of the program and the failed testing of the program;
rerunning the successful testing of the program and the failed testing of the program in parallel;
analyzing the stored logging of every result during the testing of the program for determining occurrence of events during the testing of the program;
generating a timeline of the events; and
outputting the timeline of the events.
